(19) United States
(12) Patent Application Publication
(10) Pub. No.: US 2026/0066554 A1
(43) Pub. Date: Mar. 5, 2026

(54) VEHICLE BATTERY JUMP STARTER CLAMP

(71) Applicant: MILWAUKEE ELECTRIC TOOL CORPORATION, Brookfield, WI (US)

(72) Inventors: Benjamin D. Gabbard, Wauwaatosa, WI (US); Qin Chao Wu, Dongguan City (CN); Jacob D. Hadfield, Mukwonago, WI (US); Jacob W. Knight, Oconomowoc, WI (US); Michael D. Huh, Milwaukee, WI (US)

(21) Appl. No.: 19/317,898

(22) Filed: Sep. 3, 2025

Related U.S. Application Data
(60) Provisional application No. 63/690,095, filed on Sep. 3, 2024.

(51) Int. Cl. H01R 4/48; H01R 4/26; H02J 1/10; H02J 7/34

(52) U.S. Cl. CPC H01R 4/489; H01R 4/26; H02J 1/122; H02J 7/342; H01R 4/4872; H01R 2201/26

(57) ABSTRACT

A device may include a first controller including a first electronic processor and a charge control circuit. A device may include a battery pack interface configured to receive a removable and rechargeable battery pack. A device may include a battery terminal clamp configured to engage with a vehicle battery terminal, the battery terminal clamp including: a housing defining two handles, two jaws having a plurality of teeth configured for engagement with the vehicle battery terminal, and a pivot point between the jaws and the handles, wherein the teeth define a first gap and a second gap separated by an engagement tooth portion.

### BACKGROUND

The present technology relates to a vehicle battery jump starters including terminal clamps for connecting with vehicle battery terminals.

### SUMMARY

Vehicle battery jump starters are subject to a number of design limitations that make the implementation of a vehicle battery jump starter difficult. For example, vehicle battery terminals are often difficult to reach with battery jump starter clamps. These jump starter clamps may include a plurality of clamp teeth and a thin shape. As a result of the thin shape, the jump starter clamps may include a large gap between the clamp teeth. However, because the clamp teeth has a large gap, in situations in which the vehicle battery has small terminals, the vehicle battery jump starter clamps may lack sufficient contact with the battery terminal to jump start a vehicle battery.

In some aspects, the techniques described herein relate to a vehicle battery jump starter including a first controller having a first electronic processor and a charge control circuit, a battery pack interface configured to receive a removable and rechargeable battery pack, and a battery terminal clamp configured to engage with a vehicle battery terminal. The battery terminal clamp includes a housing defining two handles, two jaws having a plurality of teeth configured for engagement with the vehicle battery terminal, and a pivot point between the jaws and the handles. The teeth define a first gap and a second gap separated by an engagement tooth portion.

In other aspects, the techniques described herein relate to a terminal battery clamp configured to engage with a vehicle battery terminal, the terminal battery clamp includes a housing defining two handles and two jaws having a number of teeth configured for engagement with the vehicle battery terminal. The terminal battery clamp further includes a pivot point between the jaws and the handles, wherein the teeth define a first gap and a second gap separated by an engagement tooth portion.

In other aspects, the techniques described herein relate to a terminal battery clamp configured to engage with a vehicle battery terminal, the terminal battery clamp includes a housing defining two handles and two jaws having a number of teeth configured for engagement with the vehicle battery terminal. The terminal battery clamp further includes a pivot point between the jaws and the handles, wherein the teeth define a first gap and a second gap separated by an engagement tooth portion. The battery terminal clamp is further configured such that in response to a user squeezing the handles together, the user exerts a force FA and wherein in response to the user releasing the handles, the first terminal clamp is configured to exert a first clamping force FC1 at a first contact portion on a vehicle battery terminal and a second clamping force FC2 at the engagement tooth portion on the vehicle battery terminal.

Before any embodiments of the invention are explained in detail, it is to be understood that the invention is not limited in its application to the details of the configuration and arrangement of components set forth in the following description or illustrated in the accompanying drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components may be utilized to implement the invention. For example, “servers” and “computing devices” described in the specification can include one or more processing units, one or more computer-readable medium modules, one or more input/output interfaces, and various connections (e.g., a system bus) connecting the components.

Other aspects of the invention will become apparent by consideration of the detailed description and accompanying drawings.

### BRIEF DESCRIPTION OF THE DRAWINGS

FIG. 1 is a perspective view of a battery pack, according to some embodiments.

FIG. 2 is a top view of the battery pack of FIG. 1, according to some embodiments.

FIG. 3 is a section view of the battery pack of FIG. 1 showing battery cells, according to some embodiments.

FIG. 4 is an electromechanical diagram of the battery pack of FIG. 1, according to some embodiments.

FIG. 5 illustrates a vehicle battery jump starter configured to receive, support, and be powered by the battery pack of FIG. 1, according to some embodiments.

FIG. 6A is a perspective view of a clamp of the vehicle battery jump starter of FIG. 5.

FIG. 6B is another perspective view of a clamp of the vehicle battery jump starter of FIG. 5.

FIG. 7 is an electromechanical diagram of the vehicle battery jump starter of FIG. 5, according to some embodiments.

### DETAILED DESCRIPTION

This technology relates to a vehicle battery jump starter that is powered by a removable and rechargeable battery pack, such as a battery pack used with various hand-held power tools. The battery pack removably connects to a vehicle battery jump starter. The battery pack, or a plurality of battery packs connected together, can be used to power the vehicle battery jump starter and jump start a vehicle battery. The vehicle battery jump starter further includes battery terminal clamps configured to engage with and make an electrical connection with the battery terminals of the vehicle battery needing jump starting. The battery terminal clamps, for example, have a plurality of teeth which mirror the shape of a crocodile's teeth to achieve a superior electrical connection with the battery terminal and higher clamping forces. The battery terminal clamps in combination with the removable and rechargeable battery pack are used to jump start a vehicle battery.

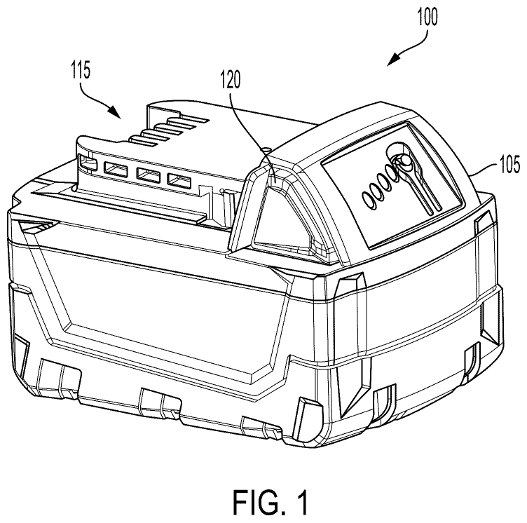

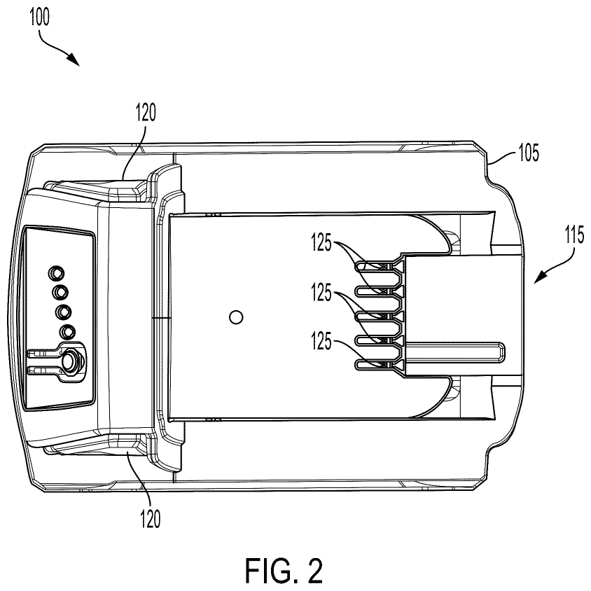

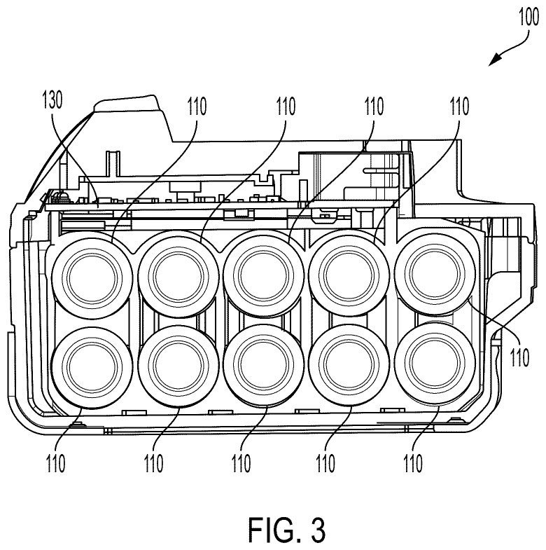

FIGS. 1-3 illustrate a battery pack 100 for use with a vehicle battery jump starter. The battery pack 100 is connectable to and supportable by hand-held power tools such as drills, fasteners, saws, pipe cutters, sanders, nailers, staplers, vacuum cleaners, etc. The battery pack 100 is also connectable to and supportable by outdoor power tools such as string trimmers, hedge trimmers, blowers, chain saws, etc. As shown in FIGS. 1-3, the battery pack 100 includes a housing 105 and at least one rechargeable battery cell 110 (shown in FIG. 3) supported by the housing 105. The battery pack 100 also includes a support portion 115 for supporting the battery pack 100 on a tool, and a coupling mechanism 120 for selectively coupling the battery pack 100 to, or releasing the battery pack 100 from, the tool. The support portion 115 is connectable to a complementary support portion on the tool.

The battery pack 100 includes a plurality of terminals 125 located within the support portion 115 and operable to electrically connect the battery cells 110 to a PCB 130 within the battery pack 100. The plurality of terminals 125 includes, for example, a positive battery terminal, a ground terminal, and a sense or data terminal. The battery pack 100 is removably and interchangeably connected to a tool to provide operational power to the tool. The terminals 125 are configured to mate with corresponding power terminals extending from a tool within a complementary receiving portion or the tool.

The illustrated battery pack 100 includes ten battery cells 110. In other embodiments, the battery pack 100 can include additional or fewer battery cells 110. The battery cells can be arranged in series, parallel, or a series-parallel combination. For example, the battery pack can include a total of ten battery cells configured in a series-parallel arrangement of five sets of two series-connected cells. The series-parallel combination of battery cells allows for an increased voltage and an increased capacity of the battery pack. In some embodiments, the battery pack 100 includes five series-connected battery cells. In other embodiments, the battery pack 100 includes a different number of battery cells (e.g., between three and thirty battery cells) connected in series, parallel, or a series-parallel combination in order to produce a battery pack having a desired combination of nominal battery pack voltage and battery capacity.

The battery cells 110 are lithium-based battery cells having a chemistry of, for example, lithium-cobalt (“Li-Co”), lithium-manganese (“Li-Mn”), or Li-Mn spinel. In some embodiments, the battery cells 110 have other suitable lithium or lithium-based chemistries, such as a lithium-based chemistry that includes manganese, etc. The battery cells within the battery pack 100 provide operational power (e.g., voltage and current) to the tools. In one embodiment, each battery cell 110 has a nominal voltage of approximately 3.6V, such that the battery pack has a nominal voltage of approximately 18V. In other embodiments, the battery cells have different nominal voltages, such as, for example, between 3.6V and 4.2V, and the battery pack has a different nominal voltage, such as, for example, 10.8V, 12V, 14.4V, 24V, 28V, 36V, 60V, 80V, between 10.8V and 80V, etc. The battery cells 110 also each have a capacity of, for example, approximately between 1.0 ampere-hours (“Ah”) and 6.0 Ah. In exemplary embodiments, the battery cells each have capacities of approximately, 1.5 Ah, 2.4 Ah, 3.0 Ah, 4.0 Ah, 6.0 Ah, between 1.5 Ah and 6.0 Ah, etc. In some embodiments, a battery pack 100 having a total battery pack capacity of approximately 5.0 Ah or greater (e.g., 5.0 Ah to 12.0 Ah) is used in combination with a vehicle battery jump starter. In other embodiments, a battery pack 100 having a total battery pack capacity of approximately 1.5 Ah or greater (e.g., 1.5 Ah to 12.0 Ah) is used in combination with a vehicle battery jump starter.

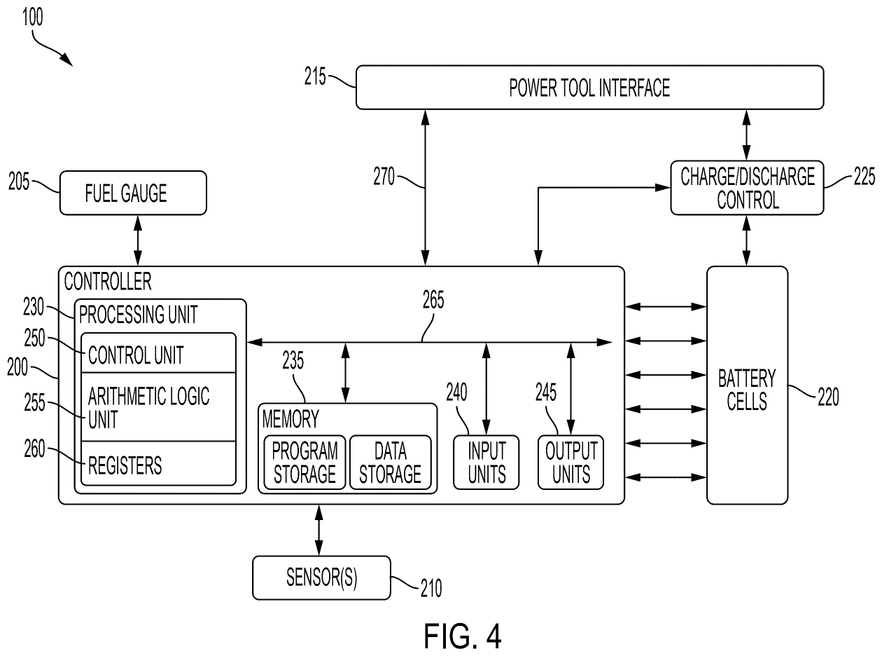

The power output by the battery pack 100 to a tool is controlled, monitored, and regulated using control electronics within the battery pack 100, a tool, or a combination thereof. FIG. 4 illustrates a controller 200 associated with the battery pack 100. The controller 200 is electrically and/or communicatively connected to a variety of modules or components of the battery pack 100. For example, the illustrated controller 200 is connected to a fuel gauge 205, one or more sensors 210, a tool interface 215, a plurality of battery cells 220, and a charge/discharge control module 225 (optional within battery pack). The controller 200 includes combinations of hardware and software that are operable to, among other things, control the operation of the battery pack 100, activate the fuel gauge 205, monitor the operation of the battery pack 100, etc. The fuel gauge 205 includes, for example, one or more indicators, such as light-emitting diodes (“LEDs”). The fuel gauge 205 can be configured to display conditions of, or information associated with, the state-of-charge of the battery cells 220. The controller 200 also includes a variety of preset or calculated fault condition values related to temperatures, currents, voltages, etc., associated with the operation of a tool.

In some embodiments, the controller 200 includes a plurality of electrical and electronic components that provide power, operational control, and protection to the components and modules within the controller 200 and/or battery pack 100. For example, the controller 200 includes, among other things, a processing unit 230 (e.g., a microprocessor, a microcontroller, or another suitable programmable device), a memory 235, input units 240, and output units 245. The processing unit 230 includes, among other things, a control unit 250, an arithmetic logic unit (“ALU”) 255, and a plurality of registers 260 (shown as a group of registers in FIG. 4), and is implemented using a known computer architecture, such as a modified Harvard architecture, a von Neumann architecture, etc. The processing unit 230, the memory 235, the input units 240, and the output units 245, as well as the various modules connected to the controller 200 are connected by one or more control and/or data buses (e.g., common bus 265). The control and/or data buses are shown generally in FIG. 4 for illustrative purposes. The use of one or more control and/or data buses for the interconnection between and communication among the various modules and components would be known to a person skilled in the art in view of the technology described herein. In some embodiments, the controller 200 is implemented partially or entirely on a semiconductor (e.g., a field-programmable gate array [“FPGA”] semiconductor) chip, such as a chip developed through a register transfer level (“RTL”) design process.

The memory 235 is a non-transitory computer readable medium that includes, for example, a program storage area and a data storage area. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The processing unit 230 is connected to the memory 235 and executes software instructions that are capable of being stored in a RAM of the memory 235 (e.g., during execution), a ROM of the memory 235 (e.g., on a generally permanent basis), or another non-transitory computer readable medium such as another memory or a disc. Software included in the implementation of the battery pack 100 can be stored in the memory 235 of the controller 200. The software includes, for example, firmware, one or more applications, program data, filters, rules, one or more program modules, and other executable instructions. The controller 200 is configured to retrieve from memory and execute, among other things, instructions related to the control of the battery pack described herein. The controller 200 can also store various battery pack parameters and characteristics (including battery pack nominal voltage, chemistry, battery cell characteristics, maximum allowed discharge current, maximum allowed temperature, etc.). In other constructions, the controller 200 includes additional, fewer, or different components.

The tool interface 215 includes a combination of mechanical components (e.g., the support portion 115) and electrical components (e.g., the plurality of terminals 125) configured to, and operable for, interfacing (e.g., mechanically, electrically, and communicatively connecting) the battery pack 100 with a tool or another device. For example, power provided from the battery pack 100 to a tool or device is provided through the charge/discharge control module 225 to the tool interface 215. The charge/discharge control module 225 includes, for example, one or more switches (e.g., FETs) for controlling the charging current to and discharge current from the battery cells 220. In some embodiments, power provided from the battery pack 100 to a tool or device (or from a charger) is controlled by a charge/discharge control module 225 that is external to the battery pack 100 (i.e., internal to a tool, device, or charger). The tool interface 215 also includes, for example, a communication line 270 for providing a communication line or link between the controller 200 and a tool or device (e.g., a vehicle battery jump starter).

The sensors 210 include, for example, one or more current sensors, one or more voltage sensors, one or more temperature sensors, etc. For example, the controller 200 uses the sensors 210 to monitor an individual state of charge of each of the battery cells 220, monitor a current being discharged from the battery cells 220, monitor the temperature of one or more of the battery cells 220, etc. If the voltage of one of the battery cells 220 is equal to or above an upper voltage limit (e.g., a maximum charging voltage), the charge/discharge control module 225 prevents the battery cells from being further charged or requests that a battery charger (not shown) provide a constant voltage charging scheme. Alternatively, if one of the battery cells 220 falls below a low-voltage limit, the charge/discharge control module prevents the battery cells 220 from being further discharged. Similarly, if an upper or lower operational temperature limit for the battery cells 220 is reached, the controller 200 can prevent the battery pack 100 from being charged or discharged until the temperature of the battery cells 220 or the battery pack 100 is within an acceptable temperature range.

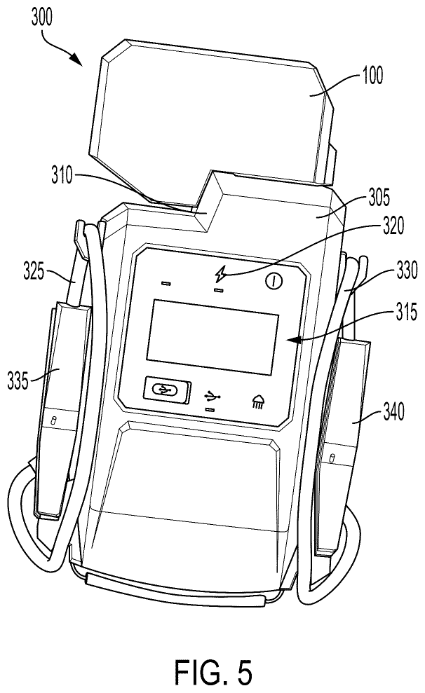

The battery pack 100 is connectable to and supportable by a vehicle battery jump starter such as vehicle battery jump starter 300 illustrated in FIG. 5. The vehicle battery jump starter 300 includes a housing 305, a support portion 310 for receiving and supporting the battery pack 100, a user interface 315 for displaying and controlling the vehicle battery jump starter 300, an ON or POWER button 320 for turning ON or activating the vehicle battery jump starter 300, a first electrical cable 325, a second electrical cable 330, a first terminal clamp 335, and a second terminal clamp 340. The battery pack 100 connects to the vehicle battery jump starter 300 through the support portion 310 and the plurality of terminals 125. As a result, the battery pack 100 operates as a power source for the vehicle battery jump starter 300.

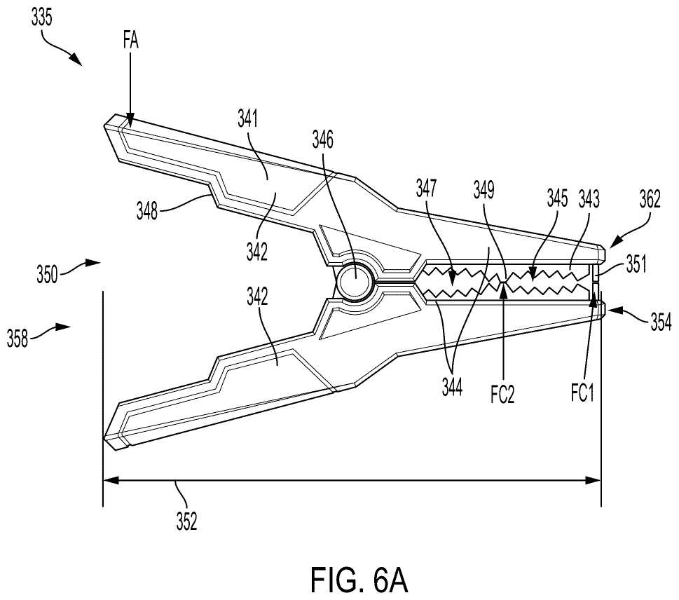

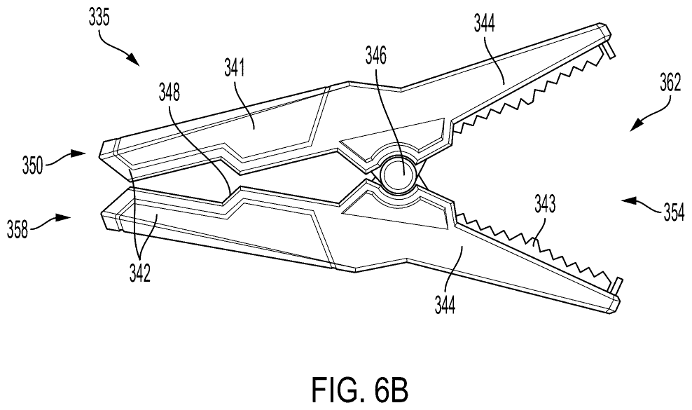

FIGS. 6A-6B illustrate the first terminal clamp 335 of the vehicle battery jump starter 300 in greater detail. While the description included herein is directed to the first terminal clamp 335, the following description can be equally applied to the second terminal clamp 340. The first terminal clamp 335 is configured to engage with a terminal of the vehicle battery needing to be jump started. In the present embodiment, the first terminal clamp 335 is a needle nose clamp to allow for the terminal clamp 335 to reach and engage with vehicle battery terminals positioned within the vehicle which may be difficult to access using standard clamping devices..

The first terminal clamp 335 includes a housing 341 defining two handles 342, two jaws 344 having a plurality of teeth 343 for engagement with a terminal of a battery (e.g., a car battery), and a pivot point 346 between the jaws 344 and the handles 342. The handles 342 are biased to a closed position by a spring (not shown) disposed about the pivot point 346 (FIG. 6A). In the present embodiment, the spring is a torsion spring, however, in alternate embodiments, the spring may be a compression spring, a leaf spring, an extension spring, or any suitable type of biasing mechanism. The handles 342 each include a jog 348 configured to reduce the size (e.g., thickness) of the handles 342. The jog 348 enables the handles 342 to be positioned close together to allow for maximizing the range of motion of the jaws 344 (FIG. 6B).

The plurality of teeth 343 are shaped to provide a large contact surface by providing several points of contact and create a large clamping force. The plurality of teeth 343 are arranged to define a first gap 345 and a second gap 347 separated by an engagement tooth portion 349. The first gap 345 is further defined by a first contact portion 351 and the second gap 347 is further defined by the housing 341. The first gap 345 and the second gap 347 allow for easier clamping of hard-to-reach terminals and higher clamping forces than a traditional needle nose clamp.

In the preferred embodiment, the first terminal clamp 335 has a length 352 of about 130 millimeters measured from a first end 350 defined by the handles 342 to a second end 354 defined by the jaws 344. The pivot point 346 is located at a midway point along the length 352 of the first terminal clamp 335. Accordingly, the pivot point 346 is measured to be about 65 millimeters from a distal end 358 of the handles 342 and about 65 millimeters from a proximal end 362 of the jaws 344. Additionally, the pivot point 346 is measured to be about 32.5 millimeters from the engagement portion 349. It should be understood that the above-mentioned measurements are directed to a preferred embodiment, but the measurements may differ in other embodiments as required for a given application.

The first terminal clamp 335 is configured such that when a user squeezes the handles 342 together, the user exerts a force FA on the handles 342. In response to the user releasing the handles 342 (e.g., when the first terminal clamp 335 is positioned around a vehicle battery terminal), the first terminal clamp 335 is configured to exert a first clamping force FC1 at the first contact portion 351 on a vehicle battery terminal and a second clamping force FC2 at the engagement tooth portion 349 on the same vehicle battery terminal. In the preferred embodiment, the first clamping force FC1 is about equal to the force FA exerted on the handles 342. In the preferred embodiment, the second clamping force FC2 is greater than double the force FA exerted on the handles 342. In alternate embodiments, the first clamping force FC1 and the second clamping force FC2 may exert greater or less force on the vehicle battery terminal.

In operation, a user squeezes the handles 342 of the first terminal clamp 335 such that the jaw 344 opens about the pivot point 346, allowing the user to position the first terminal clamp 335 around the terminal, thereby exerting a first clamping force FC1 and a second clamping force FC2 around the terminal upon the user releasing the handles 342.

Traditional needle nose clamps typically include a large gap. As a result, the traditional needle nose clamps may lack sufficient contact with the battery terminal to jump start a vehicle battery. In contrast, the proposed design includes a terminal clamp 335 having two smaller gaps 345, 347. The two gaps 345, 347 allow for greater clamping forces (FC1, FC2) than that of traditional needle nose clamps. Additionally, the second gap 347 of the terminal clamp 335 is reduced in comparison to the size of a gap in traditional needle nose clamps, allowing for improved contact and engagement with the vehicle battery terminal. Having multiple gaps 345, 347 provides additional advantages depending on the position of the terminal. For example, the first gap 345 is configured to provide easier access to far away or hard to reach terminals. On the other hand, the second gap 347 is configured to provide more force FC2 for harder to clamp onto terminals.

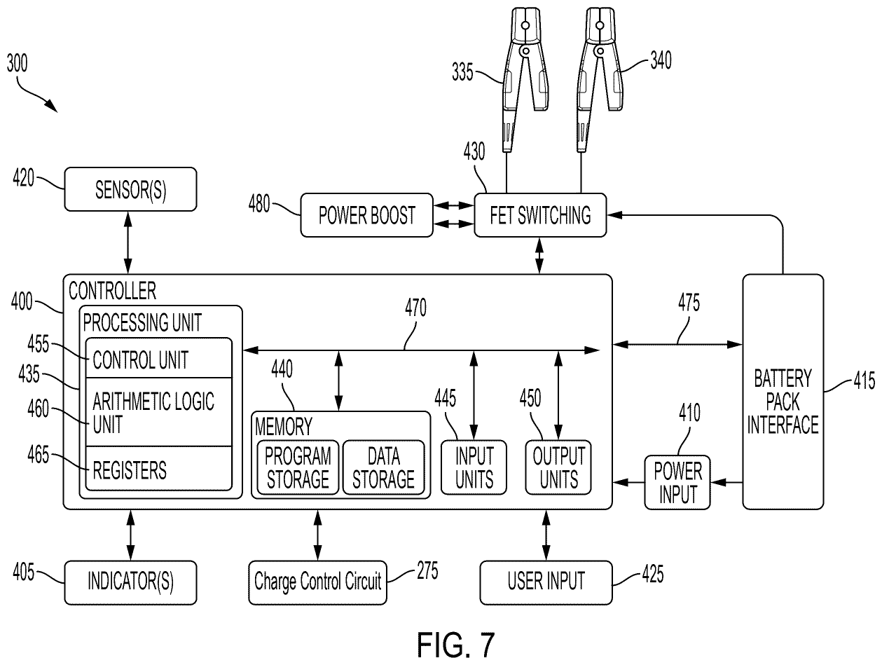

The vehicle battery jump starter 300 may also include a controller 400, as shown in FIG. 7A device may include a first controller including a first electronic processor and a charge control circuit. A device may include a battery pack interface configured to receive a removable and rechargeable battery pack. A device may include a battery terminal clamp configured to engage with a vehicle battery terminal, the battery terminal clamp including: a housing defining two handles, two jaws having a plurality of teeth configured for engagement with the vehicle battery terminal, and a pivot point between the jaws and the handles, wherein the teeth define a first gap and a second gap separated by an engagement tooth portion.. The controller 400 is electrically and/or communicatively connected to a variety of modules or components of the vehicle battery jump starter 300. For example, the illustrated controller 400 is connected to one or more indicators 405, a power input module 410, a battery pack interface 415, one or more sensors 420, a user input module 425, and a FET switching module 430. The controller 400 includes combinations of hardware and software that are operable to, among other things, control the operation of the vehicle battery jump starter 300, activate the one or more indicators 405 (e.g., an LED), monitor the operation of the vehicle battery jump starter 300, etc. The one or more sensors 420 include, among other things, one or more voltage sensors, one or more current sensors, one or more temperature sensors, etc.

In some embodiments, the controller 400 includes a plurality of electrical and electronic components that provide power, operational control, and protection to the components and modules within the controller 400 and/or vehicle battery jump starter. For example, the controller 400 includes, among other things, a processing unit 435 (e.g., a microprocessor, a microcontroller, or another suitable programmable device), a memory 440, input units 445, and output units 450. The processing unit 435 includes, among other things, a control unit 455, an ALU 460, and a plurality of registers 465 (shown as a group of registers in FIG. 6), and is implemented using a known computer architecture, such as a modified Harvard architecture, a von Neumann architecture, etc. The processing unit 435, the memory 440, the input units 445, and the output units 450, as well as the various modules connected to the controller 400 are connected by one or more control and/or data buses (e.g., common bus 470). The control and/or data buses are shown generally in FIG. 6 for illustrative purposes. The use of one or more control and/or data buses for the interconnection between and communication among the various modules and components would be known to a person skilled in the art in view of the technology described herein. In some embodiments, the controller 400 is implemented partially or entirely on a semiconductor (e.g., an FPGA semiconductor) chip.

The memory 440 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 435 is connected to the memory 440 and executes software instructions that are capable of being stored in a RAM of the memory 440 (e.g., during execution), a ROM of the memory 440 (e.g., on a generally permanent basis), or another non-transitory computer readable medium such as another memory or a disc. Software included in the implementation of the vehicle battery jump starter can be stored in the memory 440 of the controller 400. The software includes, for example, firmware, one or more applications, program data, filters, rules, one or more program modules, and other executable instructions. The controller 400 is configured to retrieve from memory and execute, among other things, instructions related to the control processes and methods described herein. In other constructions, the controller 400 includes additional, fewer, or different components.

Thus, the technology provides, among other things, a vehicle battery jump starter including terminal clamps.

What is claimed:

1. A vehicle battery jump starter comprising:
a first controller including a first electronic processor and a charge control circuit;
a battery pack interface configured to receive a removable and rechargeable battery pack; and
a battery terminal clamp configured to engage with a vehicle battery terminal, the battery terminal clamp including:
a housing defining two handles,
two jaws having a plurality of teeth configured for engagement with the vehicle battery terminal, and
a pivot point between the jaws and the handles,
wherein the teeth define a first gap and a second gap separated by an engagement tooth portion.

2. The vehicle battery jump starter of claim 1, wherein the battery terminal clamp is configured such that in response to a user squeezing the handles together, the user exerts a force FA.

3. The vehicle battery jump starter of claim 2, wherein in response to the user releasing the handles, the first terminal clamp is configured to exert a first clamping force FC1 at a first contact portion on a vehicle battery terminal and a second clamping force FC2 at the engagement tooth portion on the vehicle battery terminal.

4. The vehicle battery jump starter of claim 3, wherein the first clamping force FC1 is about equal to the force FA exerted on the handles.

5. The vehicle battery jump starter of claim 3, wherein the second clamping force FC2 is greater than double the force FA exerted on the handles.

6. The vehicle battery jump starter of claim 1, wherein the handles include a jog configured to reduce a thickness of the handles.

7. The vehicle battery jump starter of claim 6, wherein the jog enables the handles to be positioned close together to maximize a range of motion of the jaws.

8. A terminal battery clamp configured to engage with a vehicle battery terminal, the terminal battery clamp including:
a housing defining two handles,
two jaws having a plurality of teeth configured for engagement with the vehicle battery terminal, and
a pivot point between the jaws and the handles,
wherein the teeth define a first gap and a second gap separated by an engagement tooth portion.

9. The terminal battery clamp of claim 8, wherein the battery terminal clamp is configured such that in response to a user squeezing the handles together, the user exerts a force FA.

10. The terminal battery clamp of claim 9, wherein in response to the user releasing the handles, the first terminal clamp is configured to exert a first clamping force FC1 at a first contact portion on a vehicle battery terminal and a second clamping force FC2 at the engagement tooth portion on the vehicle battery terminal.

11. The terminal battery clamp of claim 10, wherein the first clamping force FC1 is about equal to the force FA exerted on the handles.

12. The terminal battery clamp of claim 10, wherein the second clamping force FC2 is greater than double the force FA exerted on the handles.

13. The terminal battery clamp of claim 8, wherein the handles include a jog configured to reduce a thickness of the handles.

14. The terminal battery clamp of claim 13, wherein the jog enables the handles to be positioned close together to maximize a range of motion of the jaws.

15. The terminal battery clamp of claim 8, wherein the terminal battery clamp is further configured to interface with a battery-powered jump start device.

16. A terminal battery clamp configured to engage with a vehicle battery terminal, the battery terminal clamp including:
a housing defining two handles,
two jaws having a plurality of teeth configured for engagement with the vehicle battery terminal, and
a pivot point between the jaws and the handles,
wherein the teeth define a first gap and a second gap separated by an engagement tooth portion;
wherein the battery terminal clamp is configured such that in response to a user squeezing the handles together, the user exerts a force FA, and
wherein in response to the user releasing the handles, the first terminal clamp is configured to exert a first clamping force FC1 at a first contact portion on a vehicle battery terminal and a second clamping force FC2 at the engagement tooth portion on the vehicle battery terminal.

17. The terminal battery clamp of claim 16, wherein the first clamping force FC1 is about equal to the force FA exerted on the handles.

18. The terminal battery clamp of claim 16, wherein the second clamping force FC2 is greater than double the force FA exerted on the handles.

19. The terminal battery clamp of claim 16, wherein the handles include a jog configured to reduce a thickness of the handles.

20. The terminal battery clamp of claim 19, wherein the jog enables the handles to be positioned close together to maximize a range of motion of the jaws.
